(19) United States
(12) Patent Application Publication
(10) Pub. No.: US 2015/0181025 A1
(43) Pub. Date: Jun. 25, 2015

(54) Private Calling Number for Advertisements

(71) Applicant: Bandwidth.com, Inc., Raleigh, NC (US)

(72) Inventor: Ryan McBride, Cary, NC (US)

(73) Assignee: Bandwidth.com, Inc., Raleigh, NC (US)

(21) Appl. No.: 14/136,138

(22) Filed: Dec. 20, 2013

(51) Int. Cl. H04M 3/42; H04M 3/533; H04W 4/14; H04W 4/16

(52) U.S. Cl. CPC H04M 3/42008; H04W 4/16; H04M 3/533; H04W 4/14

(57) ABSTRACT

Techniques to respond to an advertisement are described. A call server may receive a telephone call to a private calling number. The telephone call may be from a buyer in response to an advertisement placed by a seller and listing the private calling number as the contact telephone number for the advertisement. The private calling number is not a personal telephone number of the seller but is associated with a personal telephone number and an SMS enabled personal telephone number of the seller. The call server may also automatically create and send an SMS text message to the SMS enabled personal telephone number of the seller in response to receiving the telephone call from the buyer. The SMS text message indicates the private calling number as the source of SMS text message and includes a telephone number of the buyer. Other embodiments are described and claimed.

### BACKGROUND

Classified advertisements for print and digital media have existed for quite some time. In general, a seller wishing to advertise an item or service can place an advertisement with a digital or print publication in which a description of the item or service is provided along with a means of contacting the seller. The contact point is typically a telephone number of the seller. Prospective buyers may read the advertisement and call the seller if interested. One of the drawbacks to this system from the perspective of the seller is that the seller's telephone number is published and used for the advertisement. Often, the seller would like to provide an anonymous telephone number rather than a personal telephone number for the advertisement.

What is needed is a classified advertisement system that allows a seller to obtain and use a temporary anonymous telephone number for a classified advertisement wherein upon expiration of the advertisement, the telephone number is returned to its source without ever having been publicly associated with the seller.

### SUMMARY

Various embodiments are generally directed to techniques to issue and manage a private calling number for a classified advertisement on behalf of a seller. Other embodiments are described and claimed.

Techniques to respond to an advertisement are described. In one embodiment, a processor component executable on a call server accessible via an IP network may execute code comprising instructions that, when executed, cause the system to receive a telephone call to a private calling number. The telephone call may be from a buyer in response to an advertisement placed by a seller and listing the private calling number as the contact telephone number for the advertisement. The private calling number is not a personal telephone number of the seller but is associated with a personal telephone number and an SMS enabled personal telephone number of the seller. The call server may also automatically create and send an SMS text message to the SMS enabled personal telephone number of the seller in response to receiving the telephone call from the buyer. The SMS text message indicates the private calling number as the source of SMS text message and includes a telephone number of the buyer.

In another embodiment, a processor component executable on a call server accessible via an IP network may execute code comprising instructions that, when executed, cause the system to receive a telephone call to a private calling number administered by the call server. The telephone call may be from a buyer in response to the advertisement placed by a seller. The private calling number may be listed as the contact telephone number for the advertisement. The private calling number is not a personal telephone number of the seller but is associated with a personal telephone number of the seller. The call server may then initiate a second telephone call from the call server to the personal telephone number of the seller using the private calling number as the source telephone number. When the seller answers the second telephone call, the call server may join the telephone call between the buyer and the call server and the telephone call between the seller and the call server to create a telephone call between the buyer and the seller. Other embodiments are described and claimed.

Certain illustrative aspects are described herein in connection with the following description and the annexed drawings. These aspects may be indicative of the various ways in which the principles disclosed herein can be practiced. In addition, these aspects and any equivalents are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a block diagram of an embodiment of a portion of a classified advertisement system to place a classified advertisement.

FIG. 2 illustrates a block diagram of a network computer advertisement server according to an embodiment.

FIG. 3 illustrates a block diagram of an advertisement data intake page according to an embodiment.

FIG. 4 illustrates a logic flow.

FIG. 5 a block diagram of an embodiment of a portion of a classified advertisement system to respond to a classified advertisement.

FIG. 6 illustrates a logic flow.

FIG. 7 illustrates a logic flow.

FIG. 8 illustrates a logic flow.

FIG. 9 illustrates an embodiment of an exemplary computing architecture suitable for implementing various embodiments as previously described.

### DETAILED DESCRIPTION

Various embodiments described herein may be implemented as part of Classified Advertisement Management System (CAMS). User interfaces to the CAMS may be browser-based, mobile/tablet application based, or computer application based tools operative on a variety of end user devices, local computer servers, and/or cloud based servers connected via one or more computer network platforms. The end user communication devices may include, without limitation, desktop computers, personal computers (PCs), laptop or notebook computers, tablet style computers, mobile devices (e.g., smartphones), and other telephony devices such as Voice-over IP (VoIP) telephony devices and plain old telephone service (POTS) telephones.

The CAMS connects publishers, telephony service providers, sellers and buyers using a platform that allows sellers to maintain anonymity with respect to buyers while allowing buyers and sellers the ability to contact one another in a variety of ways. Publishers may include entities having on-line presences (e.g., web-sites, etc.) and/or off-line presences (e.g., print newspapers, periodicals, magazines, etc.)

A seller may contact a publisher to place an advertisement. The publisher may offer the seller a private calling number option. If chosen, the advertisement will be allotted a unique telephone number not previously associated with the seller. The telephone number may be obtained from a telephony service provider from a pool of telephone numbers reserved for such purposes. The publisher may publish the ad listing the private calling number as the point of contact with the seller. When a buyer calls the private calling number in response to the advertisement, the call is routed to an advertisement call server rather than to the seller directly. Depending on the level of service chosen by the seller when placing the advertisement with the publisher, the advertisement call server may perform a variety of services that maintain the privacy of the seller that are described in greater detail below. When the advertisement has expired, the private calling number is placed into an inactive status for a pre-determined period (e.g., 2 weeks) during which time calls placed to the number will trigger a canned response pertaining to the expiration of the advertisement. Upon expiration of the pre-determined period the private calling number is transitioned back to the telephony service provider and subjected to a standard aging pool process before it can be re-used for another classified advertisement.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

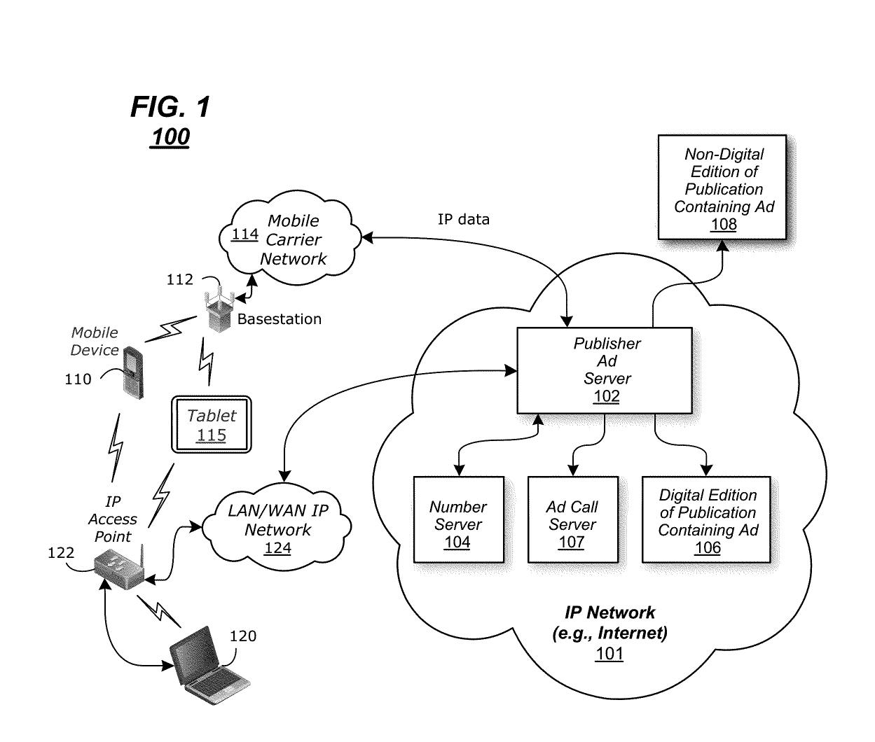

FIG. 1 illustrates a block diagram of an embodiment of a portion 100 of a classified advertisement management system to place a classified advertisement. For purposes of illustration, the system infrastructure may be referred to as a Classified Advertisement Management System (CAMS). In one embodiment, this portion 100 of CAMS may comprise a computer-implemented system having one or more components. Although this portion 100 of the CAMS shown in FIG. 1 has a limited number of elements in a certain topology, it may be appreciated that this portion 100 of the CAMS may include more or less elements in alternate topologies as desired for a given implementation.

This portion 100 of CAMS may be embodied as a collection of end user communication devices (e.g., mobile devices 110, tablet computers 114, laptop computers 120) having access to a variety of networks (e.g., mobile carrier network 114 and LAN/WAN IP network 124) that may be linked together and accessible to a publisher ad server 102 resident within an IP network 101 such as, for instance, the Internet.

Each of the various networks may support one or more end user communication devices. For example, the mobile carrier network 114 may support wireless RF communications over a basestation 112 using a variety of RF voice and data protocols with end user communications devices such as, for instance, mobile devices 110, RF radio equipped tablet computers 115 and/or RF radio equipped laptop computers 120. A mobile device 110 may include, but is not limited to, a cellular telephone, a so-called smartphone, a personal digital assistant (PDA) or the like. The RF protocols may include, but are not limited to, GSM, CDMA, WCDMA, CDMA2000, GPRS, Edge, HSDPA, LTE, EVDO, HSPA, UMTS, and WiMax.

The LAN network(s) 124 may support wired (e.g., Ethernet) and wireless RF communications including, but not limited to, multiple 802.11 protocols and Bluetooth™. The LAN network(s) 124 may communicate with end user communications devices such as, for instance, mobile devices 110, tablet computers 115, and laptop (or desktop) computers 120 via one or more access points 122.

The publisher ad server 102 may be further coupled or communicable with a number server 104. The number server 104 may be under the control of a telephony service provider and may issue telephone numbers upon an authorized request. In addition, the publisher ad server 102 may be communicable with other publisher servers (not shown) that enable the publisher ad server to provide content to both a digital edition of a publication 106 and a non-digital (e.g., print) edition of a publication 108. A digital edition of a publication may include a web-site and/or content that may downloaded from a computer server to an end user device by way of an Internet connection and viewable through a web browser or through a specific software application resident on the end user device.

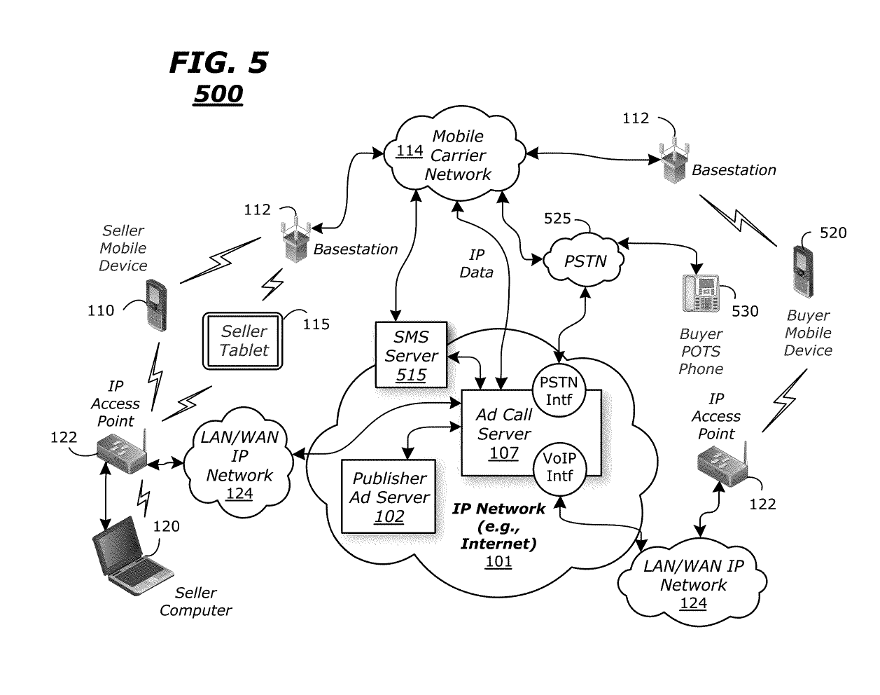

In operation, a user may access the publisher ad server 102 by way of a web-browser or device resident software application via one or more of the aforementioned communication devices using one or more of the aforementioned networks (e.g., mobile carrier network 114 or LAN network 124) and access points (e.g., basestation 112 or IP access point 122). The publisher ad server 102 may collect, via a user interface, various points of data that define or describe a proposed advertisement to be published in a publication. In addition to describing the content of the advertisement, the user may be queried whether a private calling number is desired. If so, the publisher ad server 102 may communicate with the number server 104 to obtain a telephone number for use with the advertisement. The use of a private calling number will be described in more detail below. The collected data may be used to construct an advertisement that can be run in the selected publication(s). In addition, the private calling number may be provisioned on an ad call server 107 as will be described in more detail below in FIG. 5.

It should be appreciated by those of ordinary skill in the art that additional network configurations and components may be implemented (e.g., wireless access points 122) without departing from the scope of the embodiments described herein. FIG. 1 is illustrative in nature and does not purport to capture every conceivable network or system architecture.

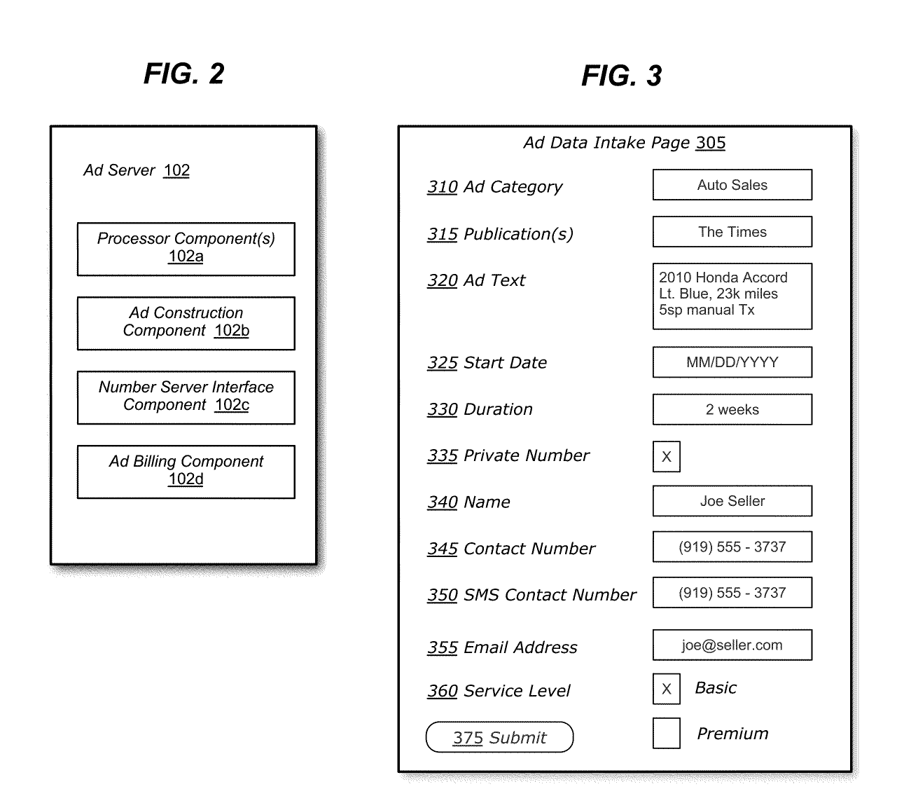

FIG. 2 illustrates a block diagram of a publisher ad server 102 according to an embodiment. The publisher ad server 102 may be functionally divided into multiple components under the control of a processor component 102a. The functional components may include an ad construction component 102b, a number server interface component 102c, and an ad billing component 102d. In addition, the publisher ad server 102 may be in functional communication with one or more memory/storage components (not shown).

The ad construction component 102b may assist the user in constructing and placing advertisement. For example, the user may interact with one or more graphical user interfaces (GUIs) designed to allow a user to create an advertisement. The GUIs may query or prompt the user for specific data about the advertisement to be placed. The number server interface component 102c may interface with a number server 104 to negotiate the use of telephone numbers. For example, if the user selects a private calling number, the number server interface component 102c may initiate a communication session with a number server 104 to requisition and obtain a telephone number to be used for the advertisement. The telephone number has no public association with the seller. The ad billing component 102d may calculate the cost of and perform the billing for an advertisement based on the selections and options chosen by the user while interacting with the ad construction component 102b. For example, the ad billing component 102d may parse the advertisement for, among other things, the number of words, whether a private number has been selected, and the duration of the advertisement. Each of these factors may have an associated cost. In addition, the ad billing component 102d may collect billing information from the user such as credit card data, bank account data, or other financial data to be used to satisfy the cost of the advertisement.

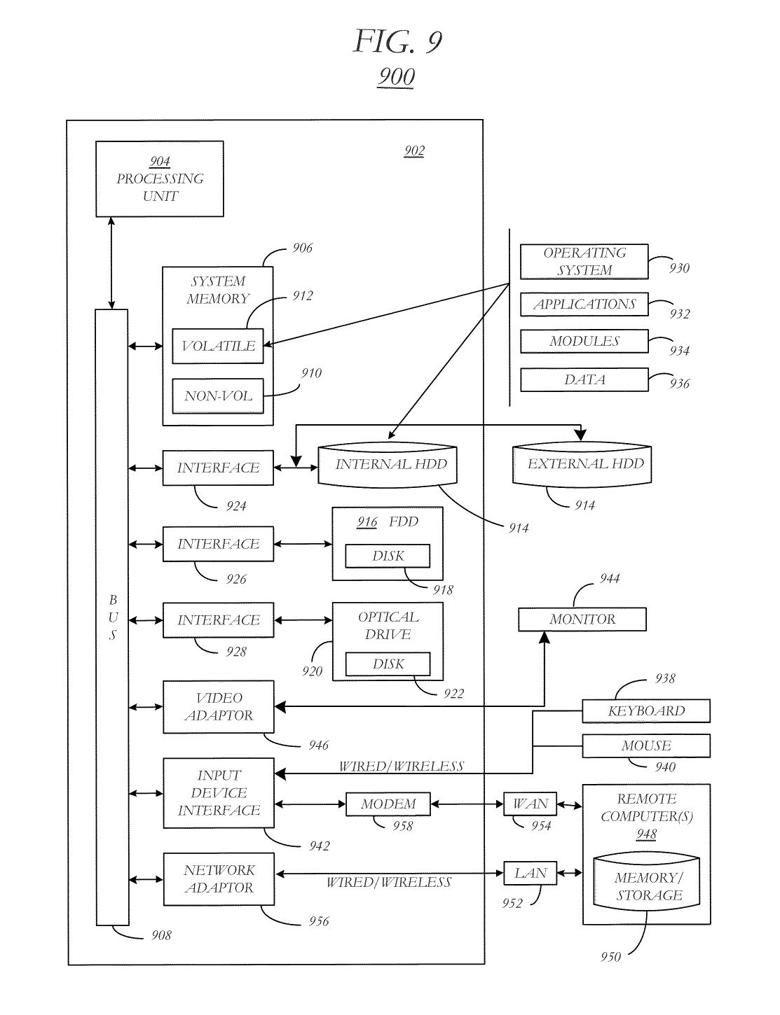

Each of the software components 102b-d may be under the control of the processor component 102a and communicable with one another using well known computer architectures. An example of such a computer architecture is described more fully with respect to FIG. 9 below.

FIG. 3 illustrates a block diagram of an advertisement data intake page 305 according to an embodiment. By way of example, FIG. 3 illustrates a sample screen shot for a GUI interface for providing data intake for a sample advertisement. A contrived advertisement for selling a used car is used to illustrate some of the data requested by the ad construction component 102b. Once the user finishes constructing the advertisement and clicks on the “submit” button 375, control may be switched to a payment screen GUI (not shown) under the control of the ad billing component 102d to process payment of the advertisement.

In addition, the look and feel of the screen shot in FIG. 3 is also exemplary. Those of ordinary skill in the art may readily customize a GUI interface and achieve the same or similar results to those discussed herein. Thus, the particular arrangement of frames or fields within the figure should not be construed as limiting.

For example, the computer screen image of the GUI does not necessarily need to be implemented via a web-browser. The computer screen image of the GUI for the ad data intake page 305 may be launched from a specific application executing on a computer or mobile device that is communicable with the publisher ad server 102. In this example, the ad data intake page 305 may be comprised of a plurality of data fields to be populated by the user. It should also be noted that the particular fields illustrated are not necessarily a complete or exhaustive list. Different publishers may have different data points used to construct and place an advertisement. Those shown in FIG. 3 are merely illustrative.

In this embodiment, the ad data intake page 305 may include data fields for an ad category 310, a publication or publications 315 in which the ad will appear, the text of the ad 320, an ad start date 325, the duration of the ad 330, whether a private calling number is desired 335, the name of the user/seller 340, a contact number for the seller 345, an SMS contact number for the seller 350, an email address for the seller, and an indication of the level of service 360 desired by the seller. The terms user and seller may be used interchangeably. In addition, some of the field may appear to prompt for text input and some may prompt for selections. The selections may be in the form of drop down menus (not shown) or check boxes. As mentioned earlier, the design of the ad data intake page 305 including the order of the fields is subject to variation and should not be considered limiting.

The ad category field 310 in this instance is for auto sales. This may have been selected from a drop down menu that contained a variety of categories including, but not limited to, auto sales, real estate, musical instruments, personal services, etc. The ad category field 310 may assist the publisher in deciding where to place the advertisement in the print and/or digital version of the publication. The publication(s) field 315 may be another drop down menu or a pop-up frame that allows the user to select one or more publications (or versions of publications—print/digital) in which the advertisement is to appear. The ad text field 320 allows the seller to construct the text of the ad that will be placed in the selected publication(s). The start date field 325 allows the seller to select the first date that the advertisement will appear in the selected publication(s). The duration field 330 specifies how long the advertisement will run in the selected publication(s) from its start date. The private number field 335 allows the seller to select an option in which a telephone number not publicly associated with the seller may be used as the point of contact for the seller. The name field 340 prompts the seller to input his/her name. The contact number field 345 prompts the seller to input a contact telephone number that the publisher ad server 102 may use (but not a buyer) to contact the seller. The SMS contact number 350 prompts the seller to input an SMS enabled telephone number that the publisher ad server 102 may use (but not a buyer) to contact the seller. The email field 355 prompts the seller to input an email address that the publisher ad server 102 may use (but not a buyer) to contact the seller. The service level field 360 prompts the user to select a level of service the seller desires for the advertisement. In this example, the seller may select basic or premium levels of service.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

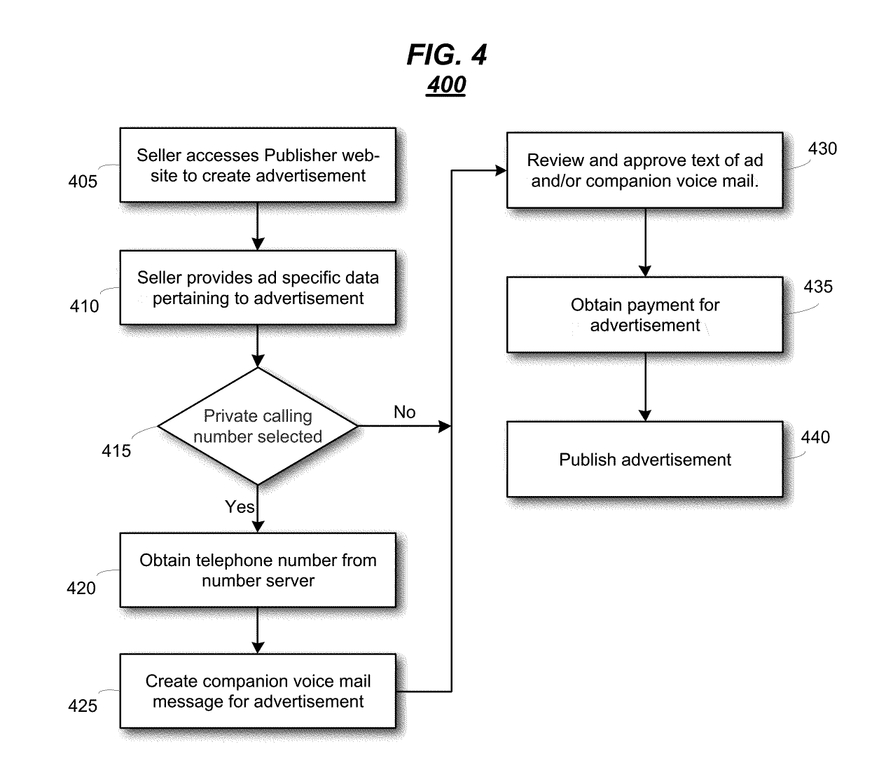

FIG. 4 illustrates one embodiment of a logic flow 400. The logic flow 400 may be representative of some or all of the operations executed by one or more embodiments described herein for allowing a seller to place an advertisement with a publisher. In the illustrated embodiment shown in FIG. 4, the logic flow 400 may provide a seller access to a publisher's ad construction component 102b at block 405. For example, the seller, via one of the communication devices described in FIG. 1 may access the publisher's ad construction component 102b over one of the computer networks also described in FIG. 1. Upon successfully navigating to the GUI for the ad construction component 102b, the seller may provide ad specific data pertaining to the advertisement at block 410. For example, the ad data intake page 305 may be presented to the seller by the ad construction component 102b. The seller may then provide the requested data to create the advertisement.

If the private calling number option has been selected at block 415 by the seller during advertisement construction, the logic flow 400 may obtain a telephone number from the number server 104 at block 420. For example, the number server interface component 102c of publisher ad server 102 may contact a number server 104 via an application programming interface (API) or other mechanism to request a telephone number. The number server may immediately reserve the telephone number for the publisher ad server 102 for a pre-defined period (e.g., 2 hours) so as to allow the publisher ad server 102 to complete the advertisement transaction with the seller. Once the publisher ad server 102 notifies the number server 104 that the transaction with the seller has been completed (including approval of ad content), the telephone number may be provisioned to the ad call server 107 and associated with a specific advertisement for an agreed upon price. If the publisher ad server 102 fails to complete the transaction with the seller within the allotted time period, the number server 104 will release the hold on the telephone number and return it to the number server's inventory of telephone numbers.

Once the private calling number has been provisioned to the ad call server 107, the seller may be prompted to create a custom voice mail greeting associated with the advertisement at block 425. For example, as part of selecting the private calling number option the seller may also be allotted a voice mailbox under the control of the ad call server 107 in which to record additional information about the item or service offered in the advertisement. The additional information may better screen the seriousness of the buyer and provide additional details about the item or service. The voice mailbox and private calling number may be associated with or hosted by the ad call server 107. The ad call server 107 (described in more detail in FIG. 5) may be a cloud based point of contact that handles communications between sellers and buyers. The ad call server 107 may also include intelligence that receives, routes and responds to buyer and seller communications that may include telephonic, SMS/MMS, and/or email.

The next step may be for the logic flow 400 to receive and review and approve the text and/or companion voice mail greeting associated with the advertisement at block 430. For example, the publisher ad server 102 may parse the written text and voice mail greeting provided by the seller to ensure compliance with any standards the publisher may have. Upon approval of the advertisement, the logic flow 400 may obtain payment for the advertisement at block 435. For example, a seller may be re-directed to a payments page (not shown) upon clicking the submit button 375 on the ad data intake page 305. In between, clicking the submit button 375 and displaying a payments page, the ad construction component 102b may verify the content of the advertisement conforms to any decency type standards the publisher may have. Payment may be obtained via any number of well known e-commerce mechanisms including, but not limited to, credit card, bank draft, PayPal™, etc.

Once payment has been obtained for the advertisement, the logic flow 400 may publish the advertisement at block 440. For example, the publisher ad server 102 may create and insert the advertisement into a print and/or digital version of the publication(s) according to the terms of the ad data intake page 305. The advertisement may then run for the designated duration from the designated start date.

FIG. 5 a block diagram of an embodiment of another portion 500 of the CAMS to respond to a classified advertisement. In one embodiment, this portion 500 of CAMS may comprise a computer-implemented system having one or more components. Although this portion 500 of the CAMS shown in FIG. 5 has a limited number of elements in a certain topology, it may be appreciated that this portion 500 of the CAMS may include more or less elements in alternate topologies as desired for a given implementation.

In this embodiment, the ad call server 107 acts as a communications hub that brokers communication between the buyer and the seller. The ad call server 107 has been provided with information about the advertisement from the publisher ad server 102 and from the number server 104. More specifically, the ad call server 107 has been configured to receive calls associated with the private calling number for the advertisement. The ad call server 107 may also be provisioned with information about the seller including the seller's contact telephone number, an SMS/MMS enabled telephone number, and an email address. The contact telephone number and the SMS/MMS enabled telephone number may be the same number. Upon receipt of a call from a buyer, the ad call server may take a plurality of actions in response thereto. Recall that the seller may have set up a custom voice mail greeting that may be played to all buyers that dial the private calling number that is associated with the advertisement. In addition, the ad call server 107 may automatically create an SMS message addressed to the seller's SMS enabled number informing the seller that a buyer at a particular phone number (as obtained by the ad call server using caller identification) is in the process of responding to your advertisement.

Other actions the ad call server 107 may take in response to a buyer dialing the private calling number include, initiating a telephonic communication link between the ad call server and the seller via seller's contact number. In this scenario, the ad call server may use the private calling number in the caller identification field when placing a call to the seller. This tells the seller that the incoming call pertains to the advertisement the seller placed. When the seller answers the call, the ad call server may connect the buyer's communication link with the ad call server 107 to the seller's communication link with the ad call server 107 to create a communication link between the buyer and the seller. Alternatively, when the seller answers the call, the ad call server may play a voice mail message left by the buyer.

Other actions the ad call server may take include, transcribing the buyer's voice mail message to text and creating an SMS and/or an email to send to the seller notifying the seller of buyer's response to the advertisement. Another feature of the ad call server 107 may allow the seller to call the buyer back via the ad call server. For example, the seller may dial the private calling number initiating a connection with the ad call server 107. Based on the caller identification being the seller's contact number, the ad call server 107 recognizes the seller and may provide a different set of options.

One of those options may be to accept DTMF input of the buyer's telephone number. The ad call server may then initiate a telephone call to the buyer using the private calling number as the initiating or source telephone number in the caller identification field. The buyer may recognize the incoming number as being associated with the ad he/she responded to and answer the call. The ad call server 107 may then bridge or connect the communication link from the seller to the ad call server 107 with the communication link between the ad call server 107 and the buyer to create a communication link between the seller and the buyer.

Alternatively, the seller may compose an SMS response to the buyer addressed to the private calling number. Specifically, the seller may place the buyer's telephone number in the subject field of the SMS or as the first ten (10) characters of the SMS message followed by a text response. The ad call server may then receive and parse the seller's SMS message and copy the text of it to a new SMS message addressed to the buyer's telephone number using the private calling number as the source of the message.

In another embodiment, the buyer may initially respond to the advertisement via SMS text message. For example, a buyer may compose an SMS text message addressed to the private calling number. The body of the SMS text message may contain a short message to the seller as well as one or more means of contacting the buyer. When the SMS text message is received by the ad call server 107, it may cause the call server to forward the SMS text message to the seller. In doing so, the ad call server 107 may address the forwarded SMS text message from the buyer to the seller's SMS enabled telephone number that is associated with the private calling number and known to the ad call server 107. Alternatively or in addition to, the ad call server 107 may package or encapsulate the SMS text message from the buyer in an email message. The ad call server 107 may compose the email message to the seller's email address containing the buyer's SMS text message. The seller's email address was provided by the seller during the ad placement process and associated with the private calling number. Once the seller receives the forwarded SMS message from the buyer via either another SMS text message or an email message on one or more communication devices of the seller, the seller may respond. One response may be to send a reply SMS text message addressed to the private calling number and including the buyer's SMS enabled telephone number. The ad call server 107 may receive the reply and compose a separate SMS text message to the buyer using the body of the seller's response SMS text message and addressed to the buyer's SMS enabled telephone number as provided in the seller's reply SMS text message. The ad call server 107 may use the private calling number as the source of the separate SMS text message back to the buyer. In doing so, the ad call server 107 strips out any reference to the seller's personal contact number(s) thereby maintaining the seller's anonymity. This process may be repeated for further communications between the buyer and seller either by SMS text message or telephone calls with the ad call server 107 always acting as an intermediary and shielding the personal contact information of the seller.

In all of the aforementioned scenarios the buyer has not been given and does not know any of the personal contact information of the seller. The ad call server 107 acts as an intermediary between the parties never revealing any of the personal information of the seller.

To carry out many of the scenarios described above, the ad call server 107 may include a Voice over IP (VoIP) interface and a Public Switched Telephone System (PSTN) interface. The ad call server 107 may also be communicable with an SMS server 515. The ad call server 107 via its VoIP, PSTN, and SMS interfaces may be communicable with a variety of IP based networks (e.g., Internet 101, LAN/WAN networks 124, access points 122) and mobile carrier networks 114, and basestations 112. These various network connections allow the ad call server 107 to reach end user communication devices including, but not limited to, mobile phones 520, VoIP telephones, POTS telephones 530, network or RF enabled tablet computers, and network or RF enabled desktop/laptop computers.

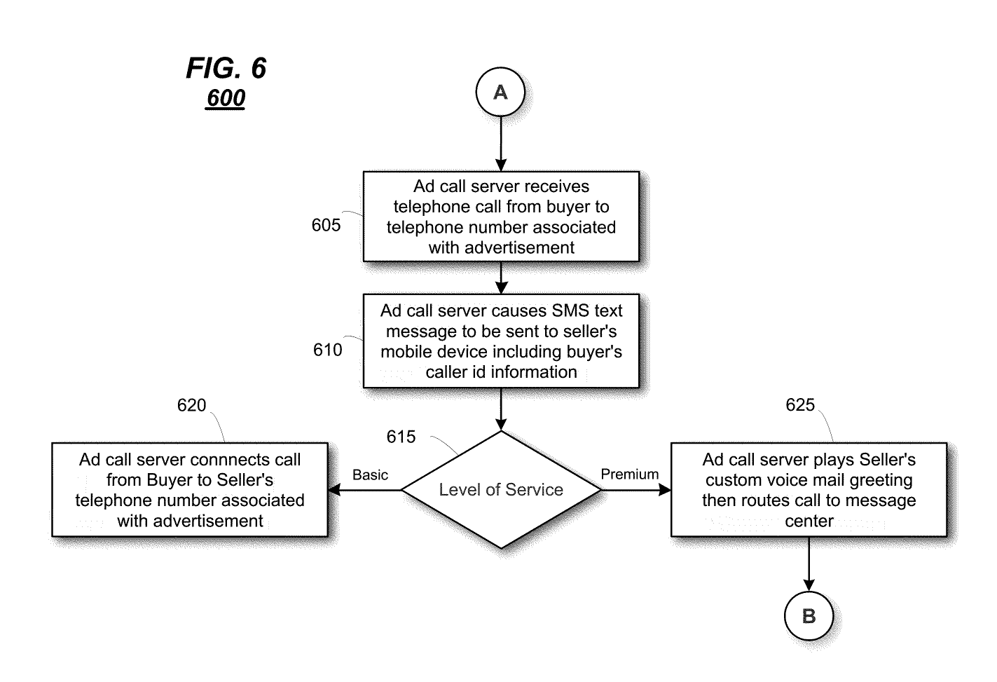

FIG. 6 illustrates one embodiment of a logic flow 600. The logic flow 600 may be representative of some or all of the operations executed by one or more embodiments described herein for allowing a buyer to respond to an advertisement. In the illustrated embodiment shown in FIG. 6, the logic flow 600 may receive a telephone call from the buyer in response to the advertisement at block 605. For example, the ad call server 107 may receive a call from a buyer to the private calling number associated with the advertisement. The ad call server 107 may then associate the incoming call with a particular advertisement and a particular seller based on the private calling number.

In the illustrated embodiment shown in FIG. 6, the logic flow 600 may automatically create an SMS message to be sent to the seller's SMS enabled telephone number at block 610. For example, the ad call server 107 may automatically compose an SMS text message to the seller to indicate that a buyer has responded to the advertisement. First the ad call server 107 looks up the private calling number to determine an associated seller's SMS enabled number. Next, the ad call server 107 composes an SMS text message to the seller's SMS enabled number. The SMS text message may be a simple notification that reads something like, “Telephone number 919-555-0987 just responded to your advertisement. Please contact the ad call server for more details.” The ad call server 107 may obtain the buyer's telephone number from the caller ID field when the buyer called the private calling number.

In the illustrated embodiment shown in FIG. 6, the logic flow 600 may determine a level of service associated with the private calling number at block 615. For example, the ad call server 107 may determine that the seller associated with the private calling number has subscribed to either a basic or a premium level of service as it pertains to the advertisement. A basic level of service may only provide a limited set of options when it comes to responding to an advertisement while a premium level of service may provide an additional set of options. It should be noted that one of ordinary skill in the art may readily devise additional levels of service beyond basic and premium. In addition, the labels “basic” and “premium” are arbitrary and used for illustration only.

In the illustrated embodiment shown in FIG. 6, the logic flow 600 may connect a communication link between a buyer and the ad call server with the seller at block 615 when the service level determined at block 615 is basic. For example, the ad call server 107 may automatically initiate a telephone call to the seller's contact number using the private calling number as the source. When the seller sees the incoming call with the private calling number as the source on his/her communication device, he/she knows it pertains to the advertisement. When the seller answers the call, the ad call server 107 may then join the first communication link between the buyer and the ad call server 107 with the newly established communication link between the ad call server 107 and the seller to create a communication link between the buyer and the seller.

Alternatively, in the illustrated embodiment shown in FIG. 6, the logic flow 600 may play the seller's custom voice mail greeting at block 625 when the service level determined at block 615 is premium. For example, the ad call server 107 may access the seller's custom voice mail greeting to provide the buyer with additional information about the item/service offered in the advertisement. The ad call server 107 determines which voice mailbox to access based on the private calling number. In addition to playing the custom voice mail greeting, the ad call server 107 may also route the buyer's call to a message center.

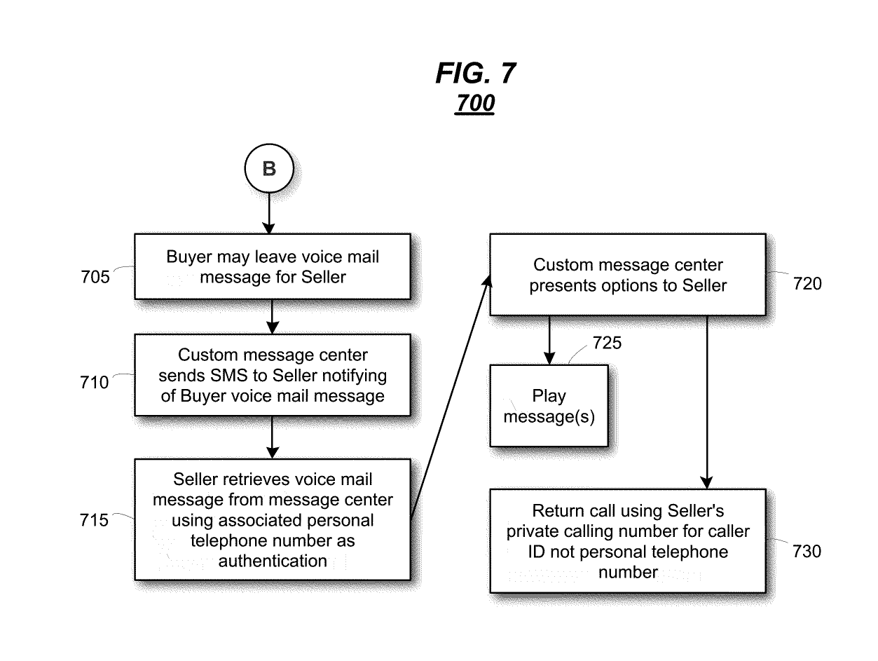

FIG. 7 illustrates one embodiment of a logic flow 700. The logic flow 700 may be representative of some or all of the operations executed by one or more embodiments described herein for providing a buyer additional options to respond to an advertisement. In the illustrated embodiment shown in FIG. 7, the logic flow 700 may permit the buyer to leave a voice mail message for the seller at block 705. For example, the ad call server 107, upon routing the buyer's call to a message center as described in FIG. 6 above, may prompt the buyer to leave a voice mail message for the seller.

In the illustrated embodiment shown in FIG. 7, the logic flow 700 may notify the seller of a voice mail message left by the buyer at block 710. For example, the ad call server 107 may initiate and create an SMS text message addressed to seller's SMS enabled phone number. The SMS text message may include a simple notification to the seller that a prospective buyer has left a voice mail message pertaining to the advertisement associated with the private calling number.

In the illustrated embodiment shown in FIG. 7, the logic flow 700 may allow the seller to retrieve the voice mail message at block 715. For example, the seller may call the private calling number to establish a communication link with ad call server 107. Ad call server 107 may recognize the incoming call as coming from the seller based on the caller ID source matching the seller's contact number as stored by the ad call server 107 and associated with the private calling number. Upon making this determination, the ad call server 107 may allow the seller access to the voice mailbox associated with the private calling number. No passcodes are necessary since the source telephone number acts as the passcode for the seller. Any other incoming call to the ad call server 107 intended for the private calling number may be treated as a buyer. Only the seller's contact number can trigger the ad call server's seller response options. An additional layer of security in the form of a PIN or passcode may, however, be implemented by the ad call server 107 to further validate the identity of the seller if desired.

In the illustrated embodiment shown in FIG. 7, the logic flow 700 may present options to the seller at block 715. For example, the message center within ad call server 107 may present one or more options to the seller for accessing and responding to voice mail messages in the voice mailbox. For example, the message center may embody an interactive voice response (IVR) type system that can prompt a caller (e.g., seller) for button or voice input and control output based on the input. One option may be to play the voice mail message(s) at block 725. The seller may listen to the voice mail message left by a particular buyer upon pressing a specified key triggering a particular DTMF tone or speaking a specified phrase (e.g., “play messages”). Another option may be to have the ad call server broker a return call to the buyer at block 730. For example, the seller may select an option to return a call to the buyer via a different button press or a voice prompt response (e.g., “Return call”). If this option is chosen the ad call server 107 may automatically initiate a call to the buyer using the private calling number as the source telephone number of the call. That way the buyer recognizes the private calling number and associates it with the advertisement. When the buyer answers the call, the ad call server 107 may join the communication link it already has established with the seller with the newly established communication link with the buyer. In this manner the seller can call the buyer without ever having to reveal any personal information such as the seller's personal telephone number. The ad call server 107 takes care of shielding the seller's personal contact information from the buyer.

Once an advertisement expires provisions may be made for returning and recycling the private calling number for future re-use.

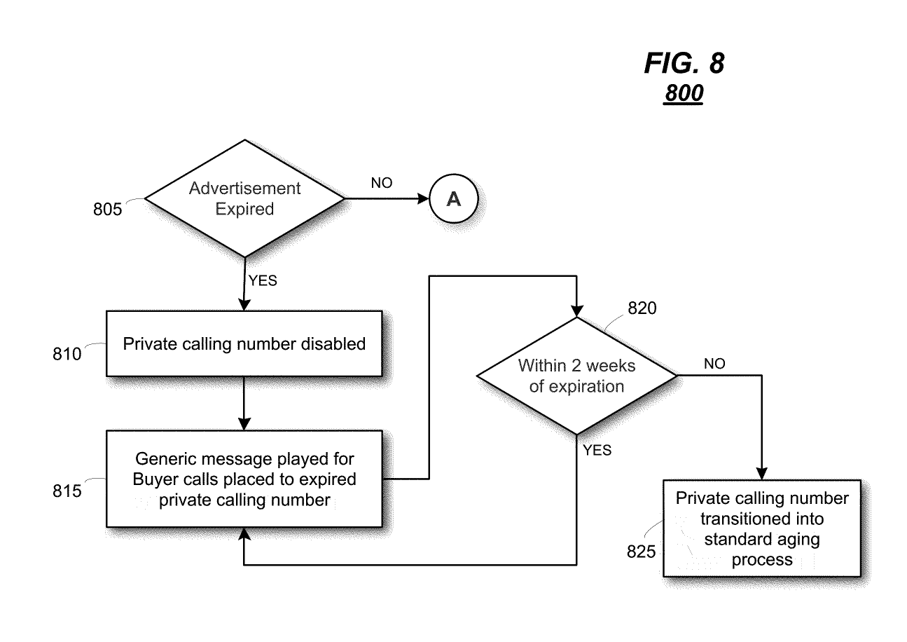

FIG. 8 illustrates one embodiment of a logic flow 800. The logic flow 800 may be representative of some or all of the operations executed by one or more embodiments described herein for handling the expiration of an advertisement. In the illustrated embodiment shown in FIG. 8, the logic flow 800 may determine if an advertisement has expired at block 805. For example, the ad call server 107 may know the start date and duration of an advertisement associated with a private calling number. Upon reaching the expiration date as calculated by the duration from the start date, the ad call server 107 determines an advertisement and its corresponding private calling number has expired. Alternatively, the publisher ad server 102 may also monitor the duration of an advertisement and send a message (email, text, or other) to the ad call server 107 that the private calling number has expired. This mechanism also allows the publisher ad server 102 to notify the ad call server 107 that an advertisement and private calling number have prematurely expired. For instance, the seller may have sold the item and no longer has a need for the service.

In the illustrated embodiment shown in FIG. 8, the logic flow 800 may disable the private calling number at block 810. For example, the ad call server may, upon determination of expiration, disable the private calling number by ceasing to perform the normal responses to incoming calls from buyers or the seller. For instance, the logic flow may substitute a generic message for the seller's voice mail message at block 815. The ad call server 107 may switch from the seller's voice mail message to a generic message such as, for example, “[T] he advertisement associated with this telephone number is no longer being offered.” This generic message may be put in place for a pre-determined time period as expressed in block 820. In this example, a pre-determined time period of two weeks has been specified but the time period is arbitrary and may be specified or changed by the number server 104, the ad call server 107, or the publisher ad server 102. If the pre-determined time period in block 820 has not yet expired, control is returned to block 815 so that the generic message may continue to play to buyers dialing the private calling number. If the pre-determined expiration period has expired, the private calling number may be transitioned into a standard aging process under the control of the number server 104 or other server(s) associated with the number server 104.

FIG. 9 illustrates an embodiment of an exemplary computing architecture 900 suitable for implementing various embodiments as previously described. In one embodiment, the computing architecture 900 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system for responding to an advertisement, comprising:
a processor component executable on a call server, the processor component executing code comprising instructions that, when executed, cause the system to:
receive a telephone call or an inbound short message service (SMS) text message to a private calling number administered by the call server, the private calling number being voice and SMS enabled, the telephone call or inbound SMS text message from a buyer in response to an advertisement placed by a seller and listing the private calling number as the contact telephone number for the advertisement, wherein the private calling number is not a personal telephone number of the seller but is associated with a personal telephone number of the seller and an SMS enabled personal telephone number of the seller; and
automatically create and send an outbound SMS text message to the SMS enabled personal telephone number of the seller in response to receiving the telephone call or SMS text message from the buyer, the outbound SMS text message indicating the private calling number as caller identification information for the outbound SMS text message and including a telephone number of the buyer in the body of the outbound SMS text message.

2. The system of claim 1, the call server storing and associating with the private calling number, (i) the personal telephone number of the seller, (ii) an SMS enabled personal telephone number of the seller, and (iii) an email address for the seller.

3. The system of claim 2, the processor component executing code comprising instructions that, when executed, cause the system to:
play a voice mail greeting pertaining to the advertisement in response to receiving the telephone call from the buyer;
prompt the buyer to record a voice mail message; and
record the voice mail message of the buyer.

4. The system of claim 3, the processor component executing code comprising instructions that, when executed, cause the system to:
transcribe the voice mail message of the buyer into text;
compose and send an email message to the email address of the seller, the email message including the telephone number of the buyer and the text of the transcribed voice mail message.

5. The system of claim 1, wherein the personal telephone number of the seller and the SMS enabled personal telephone number of the seller are the same telephone number.

6. A system for responding to an advertisement, comprising:
a processor component executable on a call server, the processor component executing code comprising instructions that, when executed, cause the system to:
receive a telephone call to a private calling number administered by the call server, the telephone call from a buyer in response to an advertisement placed by a seller and listing the private calling number as the contact telephone number for the advertisement, wherein the private calling number is not a personal telephone number of the seller but is associated with a personal telephone number of the seller; and
initiate a second telephone call from the call server to the personal telephone number of the seller using the private calling number as caller identification information for the second telephone call; and
when the seller answers the second telephone call, join the telephone call between the buyer and the call server and the telephone call between the seller and the call server to create a telephone call between the buyer and the seller.

7. A system for responding to an advertisement, comprising:
a processor component executable on a call server, the processor component executing code comprising instructions that, when executed, cause the system to:
receive a first short messaging service (SMS) text message addressed to a private calling number administered by the call server, the private calling number being voice and SMS enabled, the first SMS text message from an SMS enabled device associated with an SMS enabled telephone number of a buyer in response to an advertisement placed by a seller and listing the private calling number as the contact telephone number for the advertisement, wherein the private calling number is not a personal telephone number of the seller but is associated with an SMS enabled personal telephone number of the seller.

8. The system of claim 7, the processor component executing code comprising instructions that, when executed, cause the system to:
compose a second SMS text message on the call server to the SMS enabled personal telephone number of the seller, the second SMS text message indicating the private calling number as caller identification information for the second SMS text message, and including in the body of the second SMS text message: (i) the text of the first SMS text message sent from the SMS enabled device associated with the buyer to the private calling number, and (ii) the SMS enabled telephone number of the buyer; and
send the second SMS text message to the SMS enabled personal telephone number of the seller.
